(19) United States
(12) Patent Application Publication
(10) Pub. No.: US 2002/0071017 A1
(43) Pub. Date: Jun. 13, 2002

(54) Belt driven media transport in a printer

(76) Inventors: Gerald T. Pitpit, San Diego, CA (US); Steven J. Wirth, Escondido, CA (US); Rudolf Scherban, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/733,263

(22) Filed: Dec. 8, 2000

(51) Int. Cl. B41J 2/01

(52) U.S. Cl. 347/104

(57) ABSTRACT

A moving belt accurately transports a wide variety of media through the print zone of an ink jet printer without distortion caused by tension in the media and without pinch rollers, star wheels, nip rollers, or other media transport assisting apparatus. The belt may be horizontally mounted and may comprise a coated paper material for ink absorption and high sliding friction characteristics.

### BACKGROUND OF THE INVENTION

1. Field of the Invention

The invention relates to the transport of media under the print head of a printer. The invention has especially advantageous application to ink jet printing of textiles.

2. Description of the Related Art

In the ink jet printing process, print media is passed beneath one or more print heads which comprise a set of ink ejection nozzles. The ink ejection nozzles deposit droplets of ink onto selected pixel locations on the media under the control of data processing and control electronics in the printer. In recent years, the quality of ink jet printed images has approached photorealistic in many applications, and the use of ink jet printing technology has expanded to printing patterns on textiles for clothing, printing plastic signs, and other applications onto a diversity of substrates.

The quality of an ink jet printed product is critically dependent on the accurate placement of each individual droplet onto its intended pixel location. Because pixel sizes are often only two or three thousandths of an inch on a side, control over the relative positions of the print heads and the ink ejection nozzles must be maintained to a high tolerance.

In some ink jet printers, a motor driven grit tube, one or more rubber drive rollers, or the like are positioned along a print platen, and pinch rollers are provided at several locations to pinch the media between the pinch rollers and the driven grit tube or drive rollers. When the grit tube is incremented by a selected amount, the media is advanced beneath the print head so that the next swath of ink droplets can be deposited by the print heads. In some printers, the platen surface is covered with a driven belt that pulls the media through the print zone. In these systems, the media is under tension as it passes through the print zone. One example of this type of system is provided by U.S. Pat. No. 5,729,817 to Raymond et al. In the system described by Raymond et al., the media is preferably held under 15 pounds of tension when in the print region. In addition, many driven belt systems include pinch rollers, star wheels, or nip rollers in contact with the media as well as the driven belt. An example of a system of this type may be found in U.S. Pat. No. 5,133,616 to Oyaide et al.

These systems work acceptably in some applications. For media types which have little elasticity, such as paper or some tightly woven fabrics, these systems can feed media through the print zone with reasonable accuracy. For delicate or flexible media, however, a tensioned feed and the presence of roller elements in contact with the material can distort the media, cause wrinkling, and otherwise interfere with accurate and consistent media travel through the print zone. These feed inaccuracies result in improperly placed ink droplets and a reduction in print quality. Thus, a need exists for feed mechanisms which perform adequately with a wide range of media, including delicate and flexible materials such as knitted fabric.

### SUMMARY OF THE INVENTION

The invention includes ink jet printer embodiments which accurately and consistently feed a wide range of media types through the print region of the printer. In some advantageous embodiments, a belt drive system is provided which helps ensure accurate droplet deposition, which absorbs excess ink, and which is inexpensive to manufacture and replace.

In one embodiment, therefore, an ink jet printing method comprises contacting a substrate to be printed with a movable belt; and transporting the substrate beneath a print head using only unassisted frictional force between the belt and the substrate. Pinch rollers, star wheels, or other feed mechanisms which assist friction based advance tend to cause media distortion and reduce print quality.

Principles of the invention have been found to be especially useful for textile printing. One such method of printing textiles comprises routing a substantially untensioned textile substrate onto an approximately horizontally extending portion of a moving belt and advancing the moving belt beneath an ink jet print head so as to also advance the textile substrate beneath the ink jet print head. In some embodiments, this is done without using pinch rollers, nip rollers, star wheels, or other substrate transport apparatus.

To address other print quality issues such as ink strike through, the belt may be made of paper. The paper may be coated so as to have a higher coefficient of friction on the outside surface of the belt than on the inside surface.

### BRIEF DESCRIPTION OF THE DRAWINGS

FIG. 1 is a side plan view of an ink jet printer incorporating a media feed system in accordance with one embodiment of the invention.

FIG. 2A is a top view of a paper sheet which may be formed into a media drive belt.

FIG. 2B is a perspective view of a media drive belt suitable for use in the printer of FIG. 1.

FIG. 3 is a side view of a portion of the media drive belt of FIG. 2.

FIG. 4 is a front perspective view of an ink jet printer frame incorporating rollers for media feed and

FIG. 5 is a rear perspective view of the ink jet printer frame of FIG. 4.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

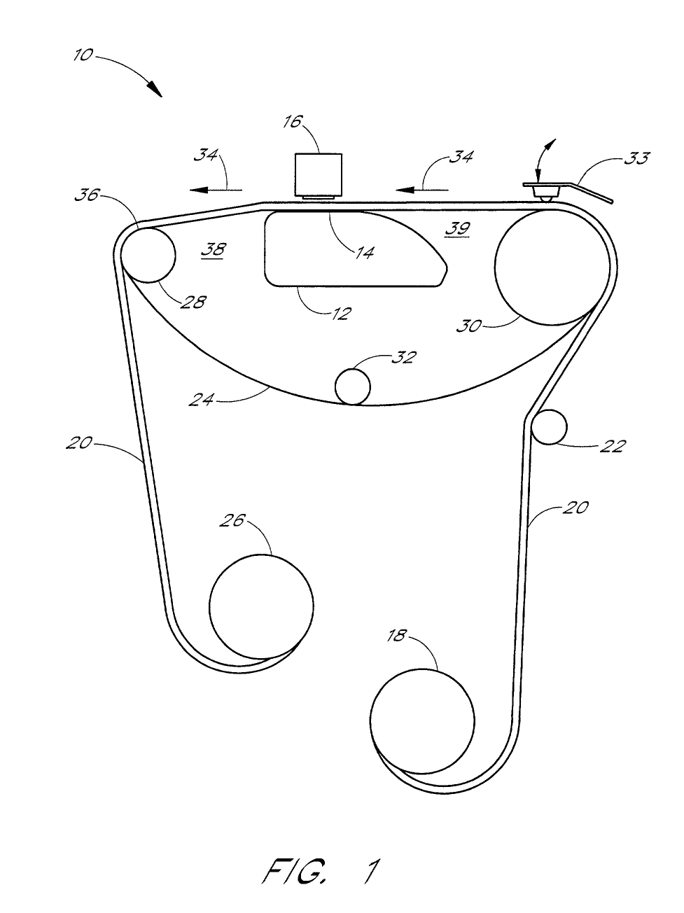

Referring now to FIG. 1, an ink jet printer 10 includes a body section 12 which is generally elongated so as to handle relatively wide media. The top of the body section 12 comprises a platen which forms a generally horizontally extending printing surface 14. Above the printing surface 14 are one or more ink jet print heads 16. As is well known, there will be four print heads in many color printer embodiments, using, for example, the cyan, magneta, yellow, and black color set.

A media feed reel 18 contains a segment of media 20 to be printed. The media 20 is routed from the feed reel 18, over a roller 22, and onto a drive belt 24 which extends over the horizontal print surface 14. After crossing over the print surface 14, the media 20 leaves the drive belt 24 and is routed to a take up reel 26.

The drive belt 24 is suspended between a front drive roller 28 and a rear roller 30, which are mounted along respective front and rear sides of the printer body 12 so that the belt 24 extends substantially horizontally across the print surface 14. A belt tensioning roller 32 may also be provided beneath the printer body 12, which will be described in additional detail below.

To assist the placement of media across the print surface 14 when a fresh roll of media 18 is installed, one or more loading bars 33 may be provided adjacent to the rear roller 30. The loading bars 33 may comprise a ball bearing that is loosely captured by a retaining arm. The retaining arm is preferably moveable such that when a new roll of media is installed, the end may be brought up over the rear roller 30, and held in place there by swinging the loading bar 33 down such that the rolling ball bearing contacts the media and holds it in place. The operator can then move to the front of the printer 10 to feed the media the rest of the way across the print surface 14, over the front drive roller 28, and down to wrap around the take up reel 26. Once the new media is fully installed, the loading bar 33 may be swung away from the rear roller 30 so that the rolling bearing is no longer in contact with the media 20.

During normal print operations, the media is incremented through the print zone in the direction of arrows 34. Between these increments, the print heads 16 pass across the print surface in the orthogonal direction (into the plane of FIG. 1) to print a swath of droplets onto the media. To perform the media increments, the front drive roller is rotated a selected amount using a stepper motor, for example. This advances the drive belt 24, and the frictional contact between the drive belt 24 and the media 20 pulls the media 20 along with the belt 24. With the embodiment of FIG. 1, media 20 advance across the print zone is performed using only unassisted frictional force between the drive belt 24 and the media 20, without the use of pinch rollers, star wheels, nip rollers, or other media transport mechanisms.

In addition, due to the absence of media drive mechanisms other than the belt 24, no driven pinch rollers or other devices are present to put additional tension on the media 20 as it passes across the print surface 14. Not only does this remove what are often mechanically complex printer components, but the lack of substantial tension in the media 20 as it passes across the print surface 14 reduces media stretching and other distortions which reduce print quality. In some advantageous embodiments, media 20 tension across the print surface 14 is less than about 1 pound. The tension may be less than about 0.5 pounds, and most advantageously is less than about 0.2 pounds. It has been found that with purely belt-driven and substantially untensioned media 20, a wide variety of media types may be printed with a large reduction in media feed induced print errors. Especially advantageous results have been found with media 20 comprising knitted fabrics or fabrics constructed from raw material which has a substantial elasticity.

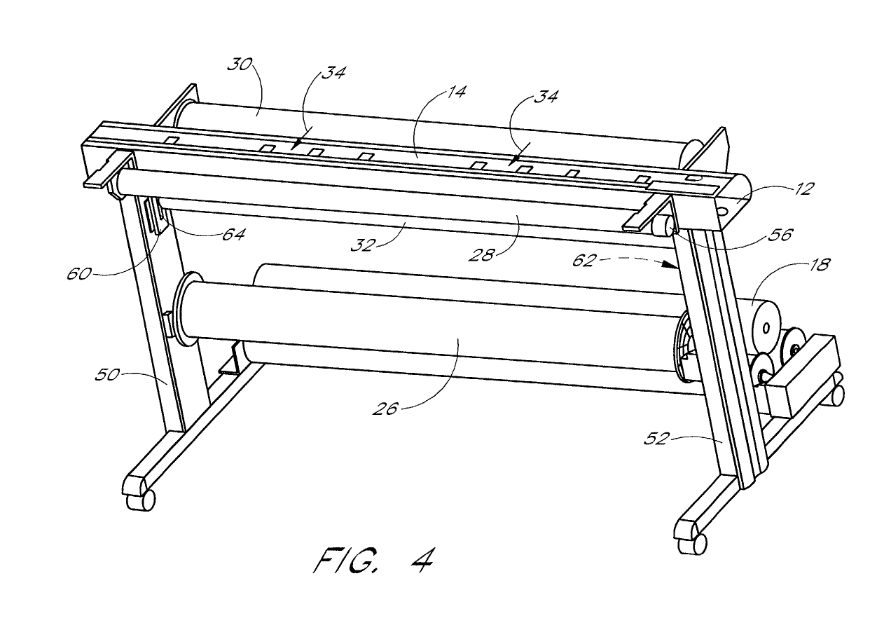

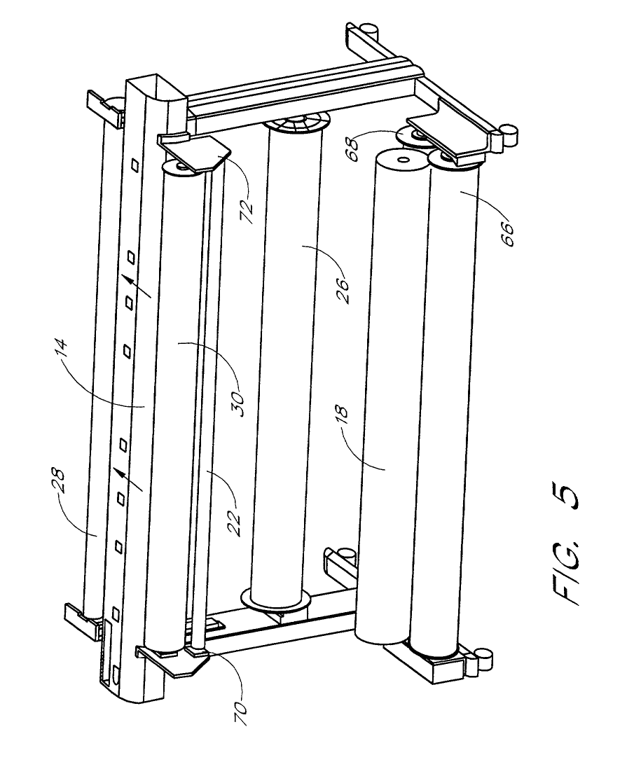

In one ink jet printer embodiment, described in additional detail below with reference to FIGS. 4 and 5, the drive roller 28 has a smaller diameter than the passive rear roller 30. In this embodiment, for example, the diameter of the front drive roller 28 is about 1-¾ to 2 inches, and the diameter of the rear roller 30 is about 5 to 5-¼ inches. although it has been found that the relative sizes of the front and rear rollers does not significantly impact the performance of the media feed mechanism It is also preferable to mount the drive roller such that its top surface 36 is at a lower level than the print surface 14. This helps ensure that the force from the tension roller 32 does not interfere with belt advance in the direction of arrows 34 as the drive roller 28 is incremented. In one implementation, support shelves (not shown) are provided in the spaces 38, 39 between the rollers 28, 30 and the printer body 12. Even though the belt 24 is supported by the printer body 12 in the print region 14, including additional supports in these regions 38, 39 minimizes the vertical bouncing motion which can be induced when the belt is advanced between print swaths.

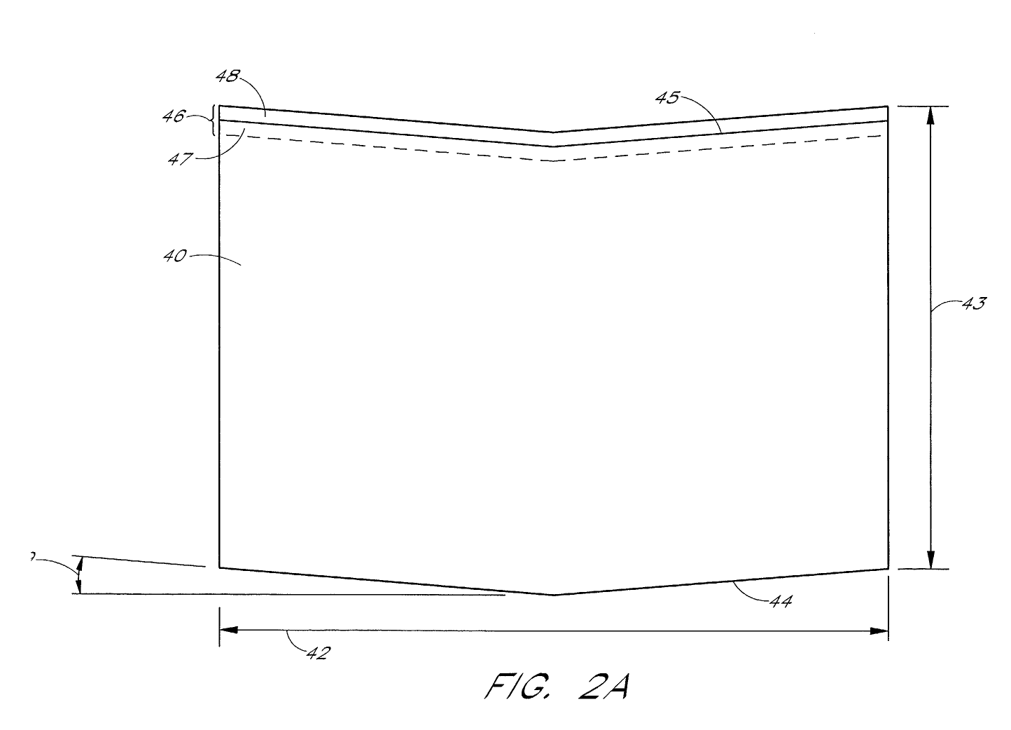

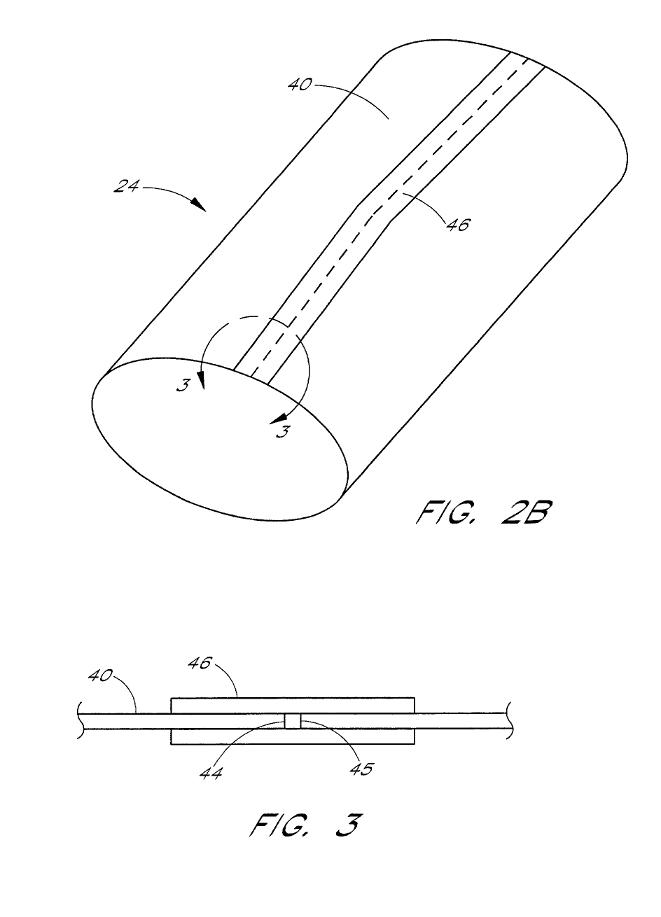

One embodiment of a media drive belt 24 suitable for use with the printing system of FIG. 1 is illustrated in FIGS. 2 and 3. To provide improvements over known belt drive systems, the belt 24 may be constructed from a paper material. Paper provides several advantages over conventional plastic or rubber media drive belts. First, paper will absorb ink which passes through the media being printed on during the print process. This is a significant concern for thin and sheer fabrics, fabric with a coarse weave, or porous materials. With plastic or rubber belts, excess ink which contacts the belt often does not dry before the belt comes into contact with fresh media on the next revolution. This can discolor the media prior to printing and severely degrade print quality.

In addition, a variety of coatings may be applied to paper in order to increase the coefficient of friction between the belt 24 and the media 20. In many conventional techniques, adhesives are used to help ensure that the media sticks sufficiently to the belt to be properly metered through the print zone. In between uses, old adhesive and excess ink is washed off, and new adhesive applied before re-using the belt. With paper, the belt itself can be disposable with minimum cost to the user.

Referring now to FIG. 2A a paper sheet 40 which may be used to form the media transport belt 24 is shown. The sheet 40 may comprise a paper material having a thickness of about 6-8 mil. In one advantageous embodiment, a 6.7 mil natural Kraft cardboard sheet having a basis weight of about 130 g/m² is used. The width and circumference of the belt may vary widely depending on the printer format the belt will be applied to. In one large format printer embodiment, the sheet 40 has a width 42 of approximately 60-¼ inches and a length 43 of approximately 41 inches between mating edges 44, 45. A strip of adhesive tape 46 is placed along one mating edge 45 so that about one-half of the width 47 is affixed to the sheet 40, and one-half of the width 48 hangs over the edge 45. Essentially any thin plastic tape is suitable for this purpose, although with an 6-8 mil thick belt 24, Kapton(TM) tape having a thickness of about 2-3 mil has been found suitable.

Although the sheet may be rectangular in shape, it has been found advantageous to cut the mating edges 44, 45 so that a shallow chevron shape is formed by the sheet 40. In one embodiment, the mating edges are cut such that about a one inch distance 49 is present between the central point of the chevron and the corners adjacent to that point. To form the sheet 40 into the belt 24, the mating edges 44, 45 are brought together, and the overhanging portion 48 of the strip of adhesive tape 46 is placed in contact with the sheet near the other mating edge 44. This process is facilitated by the chevron shape of the sheet 40, because the central points of the two mating edges 44, 45 can be accurately abutted during belt formation. In addition, the chevron shape distributes belt tension more evenly across the width of the belt when the seam created by the mating edges 44, 45 is passing over the front and rear rollers 28, 30 during print operations.

FIGS. 2B and 3 illustrate the sheet 40 after it is formed into a media drive belt 24. As described above, the mating edges 44, 45 are sealed together with the tape 46 in a butt joint configuration. The outer surface of the belt 24 is advantageously coated with a material which produces a high coefficient of friction between the belt surface and the media being fed across the print surface of the printer. Suitable coating materials include polymeric or elastomeric materials such as latex. It may also be advantageous to provide perforations in the belt 24. Because printers will often mount fans inside the printer body 12 to create a vacuum that holds the media down to the platen in the print region, such perforations allow the vacuum to continue to pull the media downward in this area.

To install a media feed belt 24, the open sheet 40 of FIG. 2A is wrapped around the drive roller 28, the rear roller 30 and the tensioning roller 32. The mating edges 44, 45 of the sheet 40 are abutted and sealed with adhesive tape as described above to form the belt around the rollers 28, 30, 32 and over the print surface 14.

FIGS. 4 and 5 illustrate a printer frame which supports the belt driven media advance system illustrated in FIG. 1. In these two Figures, the printer frame is illustrated without a belt 24 installed so as to show the belt drive components more clearly.

Referring now to FIG. 4, a floor standing printer embodiment is shown which may be utilized to print 60 inch wide rolls of fabric or other media. This printer embodiment thus includes legs 50, 52 which support the printer body 12. The media drive belt 24 (not shown) wraps around the rear roller 30 and the front roller 28, which are rotatably mounted on brackets attached to the printer body 12. The front roller 28 is driven by a stepper motor 56 to controllably advance the media drive belt through the print region in the direction of arrows 34. The media belt tensioning roller 32 is attached to brackets 60, 62 on the inner surfaces of the printer legs 50, 52. The brackets 60, 62 each include a vertical slot 64. The tensioning roller 32 is slidably mounted within these vertical slots 64 such that it can freely slide downward under the influence of gravity. When the belt 24 is installed, this downward sliding motion is stopped by contact with the inside surface of the belt 24, as is shown in FIG. 1. With this configuration, the weight of the roller 32 provides the force that tensions the belt 24. In one embodiment, approximately five pounds of tension in the belt 24 has been found to provide satisfactory performance. A higher belt tension has been found to improve line feed consistency over a range of media weights.

To further improve media feed consistency, it is also possible to include media position sensing which directly tracks the amount of media feed during the process of incrementing the media between print swaths. Such a system may comprise a wheel in contact with the top surface of the media coupled to an angular position encoder. The output of the encoder could be used to control the amount of rotation of the belt drive roller 28 so as to feed the media a precise amount with each increment even in the presence of different coefficients of friction between the belt and the media, different media weights, or other factors which may produce different media feed amounts with the same feed motor 56 advance.

As seen in FIG. 5, the media feed reel 18 rests between media feed rollers 66, 68, one of which is driven by a motor to advance media from the feed reel 18 up toward the printer body 12. As is illustrated in FIG. 1, the media from the feed reel is routed behind a roller 22, and up onto the media drive belt 24 (not shown), which is wrapped around the rear media drive belt roller 30. The media is incremented during the printing process in the direction of arrows 34 so as to drape down off of the media drive belt 24 at the front drive belt roller 28. The media is then routed to the take-up reel 26. The roller 22 may be mounted in brackets 70, 72 such that its position is horizontally adjustable. This horizontal adjustment will increase or decrease the wrap angle of the media as it is fed around the rear drive belt roller 30 and up onto the top surface of the drive belt 24. An increasing wrap angle will increase the contact area between the belt 24 and the media as it wraps around the rear roller 30 which provides an increase in frictional force during media feeding. An increase in wrap angle can also produce an increase in media tension through the print area. Depending on the type of media being printed, variations in wrap angle may be made to find a proper balance between high friction and low tension. It will be appreciated that relatively smooth and inflexible fabrics may advantageously be fed through the printer using a larger wrap angle than highly textured and flexible materials. Thus, a media transport system is provided which is user replaceable, which absorbs ink strike through, and which avoids media distortion is provided.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An ink jet printer which accurately meters a wide variety of print substrates through a print zone without substrate distortion, said ink jet printer comprising:
a movable media transport belt mounted on a pair of rollers, wherein a portion of said media transport belt is oriented approximately horizontally;
an ink jet print head located above said approximately horizontal portion of said movable media transport belt; and
a substrate supply reel and a substrate take-up reel, wherein said substrate is routed from said supply reel, onto said movable media transport belt, beneath said print head, and onto said take-up reel in a substantially untensioned manner, and wherein said substrate is advanced beneath said print head solely by motion of said movable media transport belt without the use of pinch rollers, star wheels, nip rollers, or other media transport mechanisms.

2. The ink jet printer of claim 1, additionally comprising a tensioning roller in contact with said media transport belt.

3. The ink jet printer of claim 1, wherein said media transport belt comprises paper.

4. The ink jet printer of claim 3, wherein said paper is coated with latex.

5. A printer comprising:
a print head;
first and second rollers; and
a belt comprising a paper sheet wrapped around said first and second rollers, wherein said first and second rollers are positioned with respect to said print head such that said paper sheet advances past said print head as said first and said second rollers rotate.

6. The printer of claim 5, wherein said paper sheet comprises approximately 6-8 mil thick cardboard.

7. The printer of claim 5, wherein said paper sheet is coated with latex on an outside surface thereof.

8. The printer of claim 5, wherein said paper sheet is perforated.

9. The printer of claim 5, wherein said belt is user replaceable.

10. The printer of claim 5, wherein said first roller comprises a drive roller, and wherein said drive roller has a smaller diameter than said second roller.

11. A media drive belt for a printer comprising a paper sheet having a first surface and a second surface, wherein said first surface has a higher coefficient of friction than said second surface.

12. The media drive belt of claim 11, wherein said paper sheet comprises approximately 6-8 mil thick cardboard.

13. The media drive belt of claim 11, wherein said first surface is coated with latex.

14. The media drive belt of claim 11, wherein said paper sheet is ink absorbent.

15. A method of advancing a textile substrate through an ink jet printer comprising:
routing a substantially untensioned textile substrate onto an approximately horizontally extending portion of a moving belt; and
advancing said moving belt beneath an ink jet print head so as to also advance said textile substrate beneath said ink jet print head.

16. The method of claim 15, additionally comprising tensioning said moving belt.

17. A method of printing onto a substrate comprising:
contacting said substrate with a movable belt; and
transporting said substrate beneath a print head using only unassisted frictional force between said belt and said substrate.

18. The method of claim 17, wherein said substrate comprises textile.

19. The method of claim 18, wherein said movable belt comprises paper.

20. A method of ink jet printing onto an elastic textile substrate comprising;
placing a first side of a substantially untensioned elastic textile substrate in contact with an approximately horizontally extending portion of a movable belt; and
passing said belt beneath an ink jet print head so as to also pass said elastic textile substrate beneath said ink jet print head without using pinch rollers, nip rollers, star wheels, or other substrate transport apparatus that contacts the side of said elastic textile substrate which is opposite said first side.

21. An ink jet printer comprising:
a printer body having a front side, a rear side, a first end, a second end, and a top surface defining a substantially horizontal print region;
first and second legs supporting said printer body at said first and second ends;
a first roller mounted along said front side of said printer body;
a second roller mounted along said rear side of said printer body;
a third roller having a first end slidably mounted to a bracket on said first leg and having a second end slidably mounted to a bracket on said second leg such that said third roller is free to move vertically within said brackets;
a paper belt wrapped around said printer body and said first, second, and third rollers, said paper belt supporting the weight of said third roller and being tensioned thereby.
